(19) United States
(12) Patent Application Publication
(10) Pub. No.: US 2024/0173897 A1
(43) Pub. Date: May 30, 2024

(54) SHAPING MATERIAL MANAGEMENT SYSTEM

(71) Applicant: SEIKO EPSON CORPORATION, Tokyo (JP)

(72) Inventor: Soji SHIOZAWA, MATSUMOTO-SHI (JP)

(21) Appl. No.: 18/519,199

(22) Filed: Nov. 27, 2023

(30) Foreign Application Priority Data
Nov. 28, 2022 (JP) 2022-189107

(51) Int. Cl. B29C 31/00; B29B 13/06

(52) U.S. Cl. CPC B29C 31/00; B29B 13/065; B29C 2045/7606

(57) ABSTRACT

A shaping material management system for managing a material used in a resin shaping system includes a storage unit configured to store material lot identification information and material lot state information including information as to whether a material lot is able to be input to the resin shaping system, an acquisition unit configured to acquire the material lot identification information and the material lot state information from the storage unit, a determination unit configured to determine whether to restrict input of the material lot to the resin shaping system based on the material lot state information acquired by the acquisition unit, and a screen generation unit configured to generate an operation. When the determination unit determines to restrict the input of the material lot to the resin shaping system, operations are partially restricted on the operation screen generated by the screen generation unit.

The present application is based on, and claims priority from JP Application Serial Number 2022-189107, filed Nov. 28, 2022, the disclosure of which is hereby incorporated by reference herein in its entirety.

### BACKGROUND

### 1. Technical Field

The present disclosure relates to a shaping material management system.

### 2. Related Art

JP-A-9-52269 discloses an optimal shaping condition setting system for an injection molding machine. In the optimal shaping condition setting system, a defect cause that causes the defect phenomenon is presumed based on a defect phenomenon that occurs in a shaped article.

### PATENT LITERATURE

When it is presumed that the defect cause of the shaped article is a material used for molding, a user may prohibit the use of a material supplied from a specific supply source during a specific period in molding of the shaped article. At this time, for example, when a user who determines a material to be prohibited from being used is different from a user who inputs a material to the resin shaping system, the material to be prohibited from being used may be erroneously input to the resin shaping system. Therefore, there is a demand for a technique capable of preventing erroneous input of a material to a resin shaping system.

### SUMMARY

According to a first aspect of the present disclosure, a shaping material management system is provided. The shaping material management system is a shaping material management system for managing a material used in a resin shaping system. The shaping material management system includes: a storage unit configured to store material lot identification information, which is information on a lot of the material, and material lot state information including information as to whether a material lot, which is the lot of the material, is able to be input to the resin shaping system; an acquisition unit configured to acquire the material lot identification information and the material lot state information from the storage unit; a determination unit configured to determine whether to restrict input of the material lot to the resin shaping system based on the material lot state information acquired by the acquisition unit; and a screen generation unit configured to generate an operation screen, which is a screen to be operated when the material lot is input to the resin shaping system. When the determination unit determines to restrict the input of the material lot to the resin shaping system, operations are partially restricted on the operation screen generated by the screen generation unit.

### BRIEF DESCRIPTION OF THE DRAWINGS

FIG. 1 is a diagram showing a schematic configuration of a shaping material management system.

FIG. 2 is a diagram showing a process of material lot state information change executed by a management device.

FIG. 3 is a diagram showing a material lot search screen.

FIG. 4 is a diagram showing a material lot list screen.

FIG. 5 is a diagram showing a process of material lot input executed by the management device.

FIG. 6 is a diagram showing a material lot input preparation screen.

FIG. 7 is a diagram showing a material lot input screen.

FIG. 8 is a diagram showing a material lot input available screen.

FIG. 9 is a diagram showing a material lot input stop screen.

FIG. 10 is a diagram showing a process of shaping preparation executed in a second embodiment.

FIG. 11 is a diagram showing a material drying start screen.

FIG. 12 is a diagram showing a drying information input screen.

FIG. 13 is a diagram showing a process of production preparation start.

FIG. 14 is a diagram showing a shaping job selection screen.

FIG. 15 is a diagram showing a production preparation available screen.

FIG. 16 is a diagram showing a production preparation stop screen.

FIG. 17 is a diagram showing a process of shaping preparation in a third embodiment.

FIG. 18 is a diagram showing a process of production start.

FIG. 19 is a diagram showing a production available screen.

FIG. 20 is a diagram showing a production stop screen.

FIG. 21 is a diagram showing a process of material lot input in a fourth embodiment.

FIG. 22 is a diagram showing a second material lot input screen.

FIG. 23 is a diagram showing a schematic configuration of a shaping material management system according to a fifth embodiment.

FIG. 24 is a diagram showing a schematic configuration of a shaping material management system according to a sixth embodiment.

FIG. 25 is a diagram showing an inspection lot list screen.

FIG. 26 is a diagram showing a shipping lot list screen.

### DESCRIPTION OF EMBODIMENTS

### A. First Embodiment

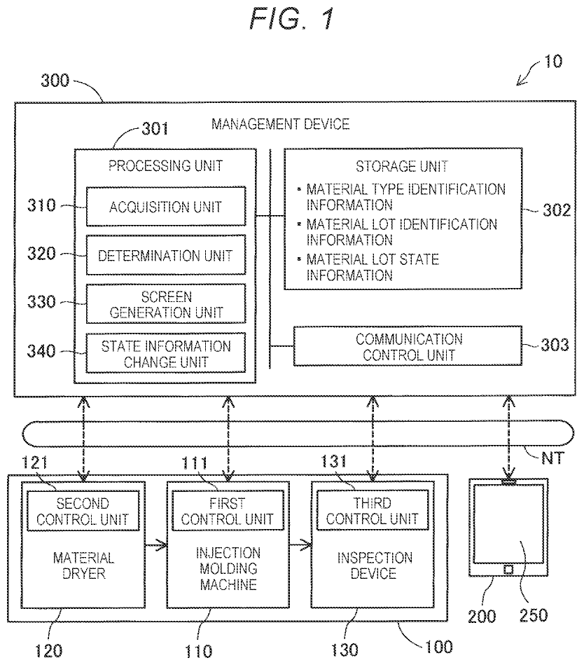

FIG. 1 is a diagram showing a schematic configuration of a shaping material management system 10. The shaping material management system 10 manages a material used in a resin shaping system 100. The shaping material management system 10 includes the resin shaping system 100, a terminal device 200, and a management device 300. In the embodiment, the resin shaping system 100 includes an injection molding machine 110, a material dryer 120, and an inspection device 130. The management device 300 is communicably connected to the injection molding machine 110, the material dryer 120, the inspection device 130, and the terminal device 200. In the embodiment, the management device 300 is able to communicate with these devices via a network NT. The network NT may be, for example, a LAN, a WAN, or the Internet. The injection molding machine 110, the material dryer 120, and the inspection device 130 may be disposed in, for example, the same housing or coupled housings, and may be integrally combined. The resin shaping system 100 may include a plurality of injection molding machines 110, a plurality of material dryers 120, and a plurality of inspection devices 130, instead of one each.

The injection molding machine 110 is a device that performs injection molding. The injection molding machine 110 includes a first control unit 111, and an injection device and a mold clamping device (both not shown). A mold having a cavity is attached to the mold clamping device. The mold may be made of metal, ceramic, or resin. A mold made of metal is referred to as a metal mold. The first control unit 111 is implemented by a computer including one or a plurality of processors, a storage device, and an input and output interface for inputting and outputting signals from and to the outside. The first control unit 111 may be implemented by a plurality of computers. A second control unit 121 of the material dryer 120 and a third control unit 131 of the inspection device 130 have a configuration same as that of the first control unit 111.

The first control unit 111 controls each unit of the injection molding machine 110 to perform injection molding and shape a shaped article. More specifically, the first control unit 111 controls the mold clamping device to clamp a mold, and controls the injection device to inject a shaping material obtained by plasticizing a material into the mold, thereby shaping a shaped article having a shape corresponding to a shape of the cavity provided in the mold. The shaped article is conveyed to the inspection device 130 by a conveying device such as a take-out robot (not shown).

The first control unit 111 transmits, to the management device 300, operation data representing a physical quantity related to injection molding. The operation data of the injection molding machine 110 includes measurement values measured by various sensors provided in the injection molding machine 110 and various command values related to the injection molding. The command values are, for example, values set in the injection molding machine 110 such as an injection filling time, an injection pressure, and a set temperature. The measurement values are values obtained by measuring an actual value of the command value with a sensor.

The material dryer 120 is a device that dries a material supplied to the injection molding machine 110. The material dryer 120 includes the second control unit 121, and a heater and a drying hopper (both not shown). The material dryer 120 removes moisture in the air with a moisture absorbent, heats the dry air by the heater, and feeds the dry air to the drying hopper to dry the material stored in the drying hopper. The second control unit 121 controls a drying temperature of the heater and an air quantity of the dry air to be fed into the drying hopper. When drying of the material is completed, the second control unit 121 transmits this fact to the management device 300. When the material dryer 120 and the injection molding machine 110 are integrally combined, the dried material is pressure-fed to the injection molding machine 110 by a pressure-feeding pump (not shown). When the material dryer 120 and the injection molding machine 110 are not integrally combined, the dried material is conveyed to the injection molding machine 110 by a user.

The inspection device 130 is a device that inspects a shaped article. The inspection device 130 includes the third control unit 131 and a camera (not shown). The third control unit 131 controls the camera to capture an image of the shaped article, and analyzes the captured image of the shaped article, thereby performing dimension measurement and appearance inspection of the shaped article. The third control unit 131 measures, for example, a height, an entire length, and an entire width of the shaped article as the dimension of the shaped article. In the appearance inspection, the third control unit 131 inspects the shaped article for a defect such as a scratch or warpage. The third control unit 131 determines whether the shaped article is defective based on results of dimension and appearance inspection for each shaped article and transmits the inspection result as a determination result to the management device 300. The inspection device 130 may measure the dimension of the shaped article using various types of displacement sensors or various types of length measuring sensors instead of the camera.

The terminal device 200 is implemented by a computer including a CPU, a storage device, and a display unit 250. As the terminal device 200, for example, a tablet terminal, a notebook computer, a smartphone, or a handy terminal can be applied. Various screens output from the management device 300 are displayed on the display unit 250. The display unit 250 may have a touch panel function. The display unit 250 may be provided in the management device 300.

The management device 300 is implemented by a computer including a processing unit 301, a storage unit 302, and a communication control unit 303. The processing unit 301 includes one or a plurality of processors and a main storage device. The storage unit 302 is implemented by an auxiliary storage device such as a hard disk drive. The communication control unit 303 includes a communication circuit for controlling communication with other devices such as the injection molding machine 110, the material dryer 120, the inspection device 130, and the terminal device 200.

The storage unit 302 stores material type identification information, material lot identification information, and material lot state information in association with one another.

The material type identification information is information on a material item, and is identification information assigned to each material item. The material type identification information is, for example, a material item name, or an ID number assigned to each material item.

The material lot identification information is information on a lot of a material. Hereinafter, the lot of the material is also referred to as a material lot. The material lot identification information is identification information assigned to each material lot. The material lot identification information is, for example, an ID number assigned to each material lot.

The material lot state information includes information as to whether the material lot can be input to the resin shaping system 100. Here, inputting the material lot to the resin shaping system 100 means inputting the material lot to the injection molding machine 110 or the material dryer 120. When the material lot can be input to the resin shaping system 100, the material lot state information is “available”. When the material lot cannot be input to the resin shaping system 100, the material lot state information is “stopped”.

Further, the operation data of the injection molding machine 110 and the inspection result of the shaped article by the inspection device 130 are stored in the storage unit 302. When the inspection result of the shaped article is defective, the material lot identification information on the material used for shaping the shaped article with the inspection result being defective and the inspection result are stored in the storage unit 302 in association with each other. The material lot identification information on the material used for shaping the shaped article and the identification information assigned to each lot of the shaped article are stored in the storage unit 302 in association with each other. A supply source of the material lot, a date when the material lot is supplied from the supply source, and the like are stored in the storage unit 302.

The processing unit 301 includes an acquisition unit 310, a determination unit 320, a screen generation unit 330, and a state information change unit 340. The acquisition unit 310, the determination unit 320, the screen generation unit 330, and the state information change unit 340 are implemented by the processing unit 301 executing a program stored in the storage unit 302. The acquisition unit 310, the determination unit 320, the screen generation unit 330, and the state information change unit 340 may be implemented by a circuit.

The acquisition unit 310 acquires information including the material lot identification information and the material lot state information from the storage unit 302.

The determination unit 320 determines whether to restrict input of the material lot to the resin shaping system 100 based on the material lot state information acquired by the acquisition unit 310.

The screen generation unit 330 generates a screen to be operated when the user manages the material. The screen generation unit 330 transmits the generated screen to the terminal device 200. The terminal device 200 acquires the screen generated by the screen generation unit 330 and displays the screen on the display unit 250.

The state information change unit 340 changes the material lot state information acquired by the acquisition unit 310.

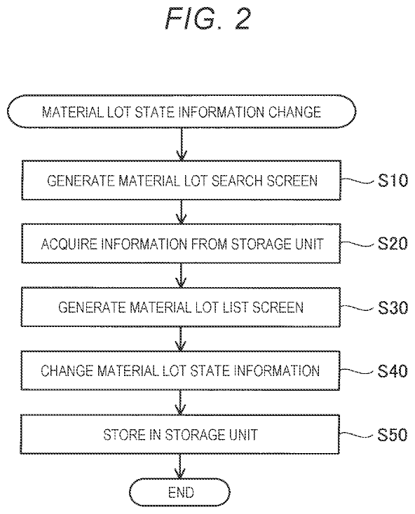

FIG. 2 is a diagram showing a process of material lot state information change executed by the management device 300. The material lot state information change is executed, for example, when a predetermined operation is performed on the management device 300 in a case where a specific material lot is presumed to be a cause of a defect of a shaped article.

In step S10, the screen generation unit 330 generates a material lot search screen SC1 for the user to search for a material lot whose material lot state information is to be changed.

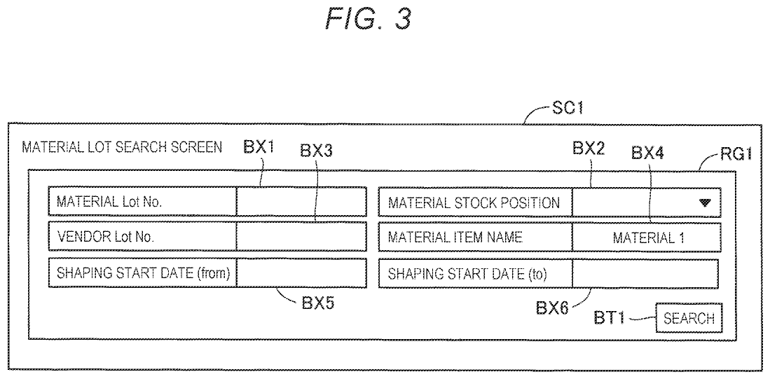

FIG. 3 is a diagram showing the material lot search screen SC1. In step S10, the user uses the material lot search screen SC1 shown in FIG. 3 to search a system of the management device 300 for the material lot whose material lot state information is to be changed. The material lot search screen SC1 is provided with a material lot search region RG1. The material lot search region RG1 is provided with an input field BX1 for inputting a material lot number as the material lot identification information, an input field BX2 for inputting a stock position of a material lot in a factory, an input field BX3 for inputting a vendor lot number which is a lot number of a material at a supply source, an input field BX4 for inputting a material item name as the material type identification information, input fields BX5 and BX6 for inputting a period during which a shaped article is shaped, and a search button BT1. The user inputs information on the material lot whose material lot state information is to be changed to at least one of the input fields BX1 to BX6, and clicks the search button BT1.

In step S20 in FIG. 2, the acquisition unit 310 acquires, from the storage unit 302, information on the material lot that matches the information input to the input fields BX1 to BX6 of the material lot search screen SC1.

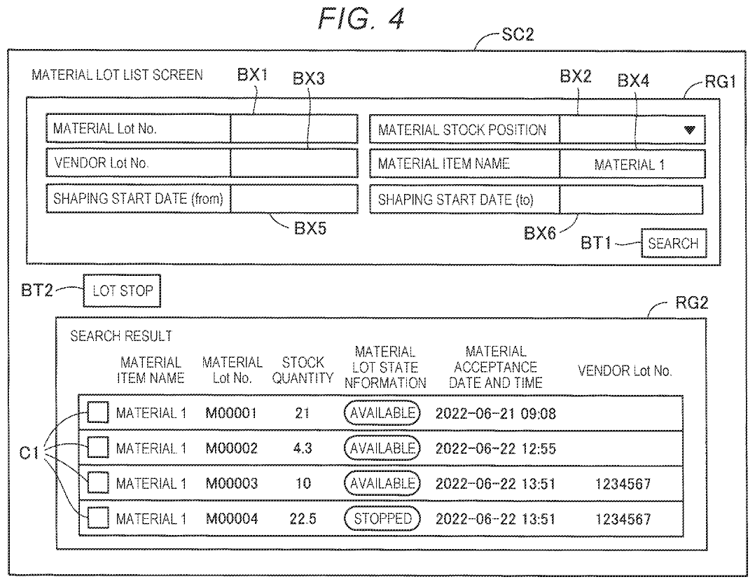

In step S30, the screen generation unit 330 generates a material lot list screen SC2 shown in FIG. 4 based on the material lot information acquired by the acquisition unit 310 in step S20.

FIG. 4 is a diagram showing the material lot list screen SC2. The material lot list screen SC2 is provided with the material lot search region RG1, a lot stop button BT2, and a search result display region RG2. A material item name as the material type identification information, a material lot number as the material lot identification information, a stock quantity of the material lot, the material lot state information, a date and time when the material lot is accepted from the supply source, and a vendor lot number are displayed on the search result display region RG2 for each material lot. When the material lot state information is “available”, the material lot state information is displayed in green, for example. When the material lot state information is “stopped”, the material lot state information is displayed in gray, for example. In the search result display region RG2, a checkbox C1 for selecting a material lot, which is associated with each material lot, is provided.

In step S40 in FIG. 2, the state information change unit 340 changes the material lot state information on the material lot not to be input to the resin shaping system 100, that is, the material lot presumed to be the cause of the defect of the shaped article. Here, the material lot presumed to be the cause of the defect of the shaped article is, for example, a material lot used for shaping a shaped article with a shaped article defective rate larger than a predetermined value or a material lot supplied from the same supply source as the above-described material lot at the same time. The user checks the checkbox C1 of the material lot with the material lot state information being “available” among the material lot not to be input to the resin shaping system 100, and clicks the lot stop button BT2. When the above-described operation is executed, the state information change unit 340 changes the material lot state information on the selected material lot from “available” to “stopped”. It is preferred that the state information change unit 340 changes the material lot state information from “available” to “stopped” when a user who has an authority to change the material lot state information operates the material lot list screen SC2.

In step S50 in FIG. 2, the processing unit 301 causes the material lot identification information and the material lot state information changed in step S40 to be stored in the storage unit 302 in association with each other. The processing unit 301 causes a date and time when the material lot state information is changed to be stored in the storage unit 302. As described above, the material lot state information change is executed.

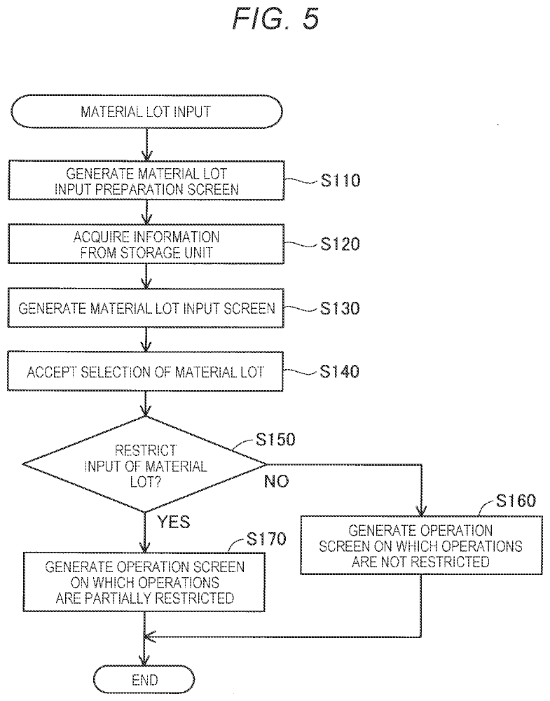

FIG. 5 is a diagram showing a process of material lot input executed by the management device 300 when a material lot is input to the resin shaping system 100, that is, when a material lot is input to the material dryer 120 or the injection molding machine 110. The material lot state information change shown in FIG. 2 is executed before the material lot input is executed.

In step S110, the screen generation unit 330 generates a material lot input preparation screen SC3 for the user to search for a material lot to be input to the resin shaping system 100.

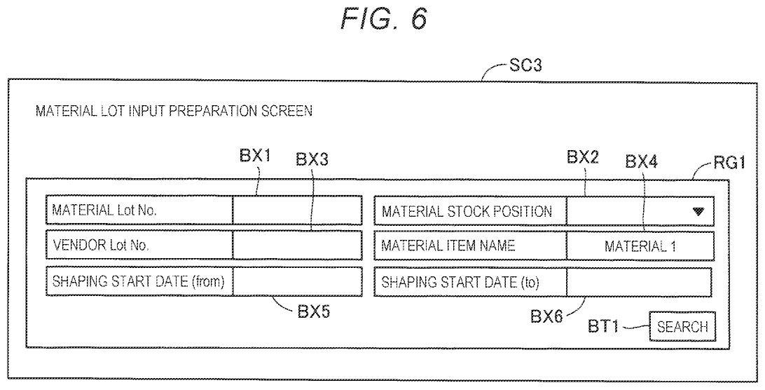

FIG. 6 is a diagram showing the material lot input preparation screen SC3. In step S110, the user uses the material lot input preparation screen SC3 to search the system of the management device 300 for the material lot to be input to the resin shaping system 100. Similar to the material lot search screen SC1 shown in FIG. 3, the material lot input preparation screen SC3 is provided with the input fields BX1 to BX6 and the search button BT1. The user inputs the material type identification information on the material to be input to the resin shaping system 100 in the input field BX4, and clicks the search button BT1.

In step S120 in FIG. 5, the acquisition unit 310 acquires, from the storage unit 302, information including the material lot identification information on the material lot composed of materials with the material type identification information input in the input field BX4 of the material lot input preparation screen SC3 and the material lot state information associated with the material lot identification information.

In step S130, the screen generation unit 330 generates a material lot input screen SC4.

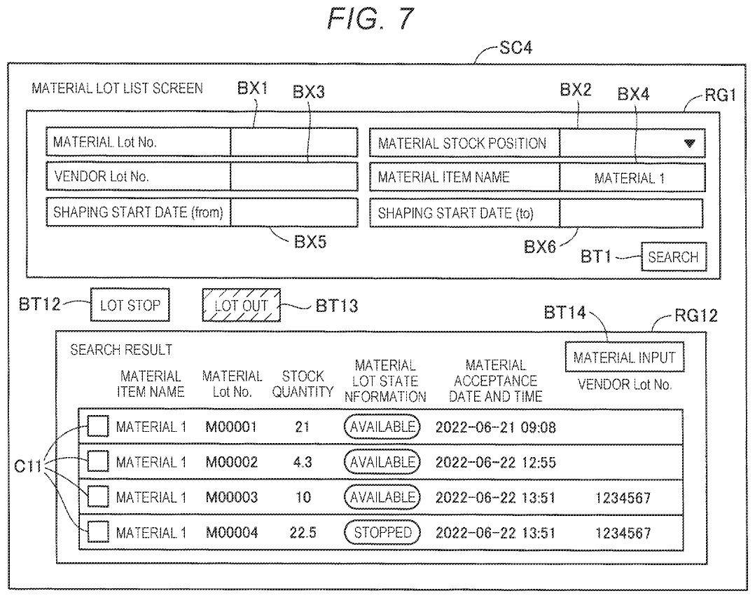

FIG. 7 is a diagram showing the material lot input screen SC4. The material lot input screen SC4 is a screen to be operated when the material lot is input to the resin shaping system 100. Here, the screen to be operated when the material lot is input to the resin shaping system 100 is also referred to as an operation screen. The material lot input screen SC4 is provided with the material lot search region RG1, a search result display region RG12, a lot stop button BT12, and a lot discard button BT13. The lot discard button BT13 is a button used when discarding the material lot. In the embodiment, the lot discard button BT13 is restricted in operation such that the user cannot click it.

A material item name as the material type identification information, a material lot number as the material lot identification information, a stock quantity of the material lot, the material lot state information, a date and time when the material lot is accepted from the supply source, and a vendor lot number are displayed on the search result display region RG12 for each material lot for which information is acquired by the acquisition unit 310 in step S120. That is, a plurality of pieces of material lot identification information are displayed in the search result display region RG12. The search result display region RG12 is provided with a material input button BT14 and a checkbox C11 for selecting a material lot, which is associated with each material lot.

In step S140 in FIG. 5, the processing unit 301 accepts, from the user, selection of a material lot to be input to the resin shaping system 100 The user checks the checkbox C11 corresponding to the material lot to be input to the resin shaping system 100 among the material lot displayed in the search result display region RG12 of the material lot input screen SC4 shown in FIG. 7, and clicks the material input button BT14.

In step S150 in FIG. 5, the determination unit 320 determines whether to restrict the input of the material lot to the resin shaping system 100 based on the material lot state information acquired by the acquisition unit 310 in step S120. When the material lot state information on the material lot selected in step S140 is “available”, the determination unit 320 determines not to restrict the input of the material lot to the resin shaping system 100. In this case, step S160 is executed after step S150. When the material lot state information on the material lot selected in step S140 is “stopped”, the determination unit 320 determines to restrict the input of the material lot to the resin shaping system 100. In this case, step S170 is executed after step S150.

In step S160, the screen generation unit 330 generates a material lot input available screen SC5, which is an operation screen on which an operation by the user is not restricted.

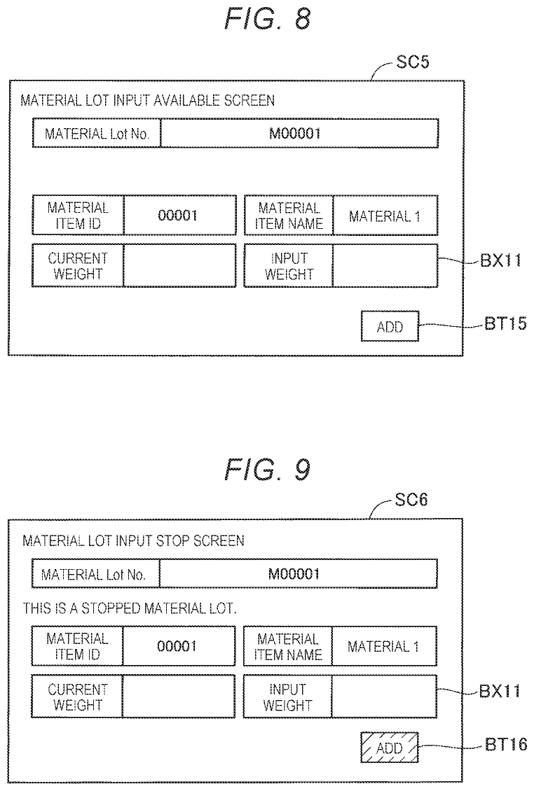

FIG. 8 is a diagram showing the material lot input available screen SC5. A material lot number which is the material lot identification information on the material lot selected in step S140 in FIG. 5 is displayed on the material lot input available screen SC5. The material lot input available screen SC5 is provided with an input field BX11 for inputting a weight of the material to be input to the resin shaping system 100, and an add button BT15. When the add button BT15 is clicked in a state where information is input in the input field BX11, the management device 300 executes input of the material lot selected in step S140 to the resin shaping system 100 on the system. The management device 300 causes, for example, a notification that the material lot is input to the resin shaping system 100 to be displayed on the display unit 250.

In step S170 in FIG. 5, the screen generation unit 330 generates a material lot input stop screen SC6, which is an operation screen on which an operation by the user is partially restricted.

FIG. 9 is a diagram showing the material lot input stop screen SC6. A material lot number which is the material lot identification information on the material lot selected in step S140, and a message “This is a stopped material lot.” are displayed on the material lot input stop screen SC6. The material lot input stop screen SC6 is provided with the input field BX11 and an add button BT16. The add button BT16 is restricted in operation such that the user cannot click it. Therefore, in step S170, the management device 300 does not execute the input of the material lot selected in step S140 to the resin shaping system 100 on the system. As described above, the material lot input is executed.

According to the shaping material management system 10 in the first embodiment described above, in the material lot state information change, the state information change unit 340 changes the material lot state information on the material lot selected by the user on the material lot list screen SC2 from “available” to “stopped”. Therefore, the user can determine a material not to be input to the resin shaping system 100.

In the embodiment, in the material lot input, the determination unit 320 determines to restrict the input of the material lot with the material lot state information being “stopped” to the resin shaping system 100. When the determination unit 320 determines to restrict the input of the material lot to the resin shaping system 100, the screen generation unit 330 generates the material lot input stop screen SC6, which is an operation screen on which operations are partially restricted. The material lot input stop screen SC6 is restricted in operation such that the user cannot click the add button BT16. Therefore, the management device 300 does not execute the input of the material lot to the resin shaping system 100 on the system. Accordingly, the material lot with the material lot state information being “stopped”, that is, the material lot not to be input to the resin shaping system 100 can be prevented from being erroneously input to the resin shaping system 100. As a result, production of a shaped article using a material lot presumed to be a cause of a defect of the shaped article can be prevented, and production of a defective article can be prevented.

When a user who executes the material lot input is different from a user who executes the material lot state information change, the user who executes the material lot input cannot input, to the resin shaping system 100, the material lot whose material lot state information is changed to “stopped” by the user who executes the material lot state information change. Therefore, the user who executes the material lot input can be prevented from erroneously inputting the material not to be input to the resin shaping system 100.

### B. Second Embodiment

In the first embodiment, the material lot state information change is executed before the material lot is input to the resin shaping system 100, that is, before the material lot is input to the material dryer 120 or the injection molding machine 110. On the other hand, in the second embodiment, the material lot state information change is executed after the material lot is input to the material dryer 120 and before the material lot input to the material dryer 120 is input to the injection molding machine 110. In the second embodiment, the material lot state information change is executed, for example, when it is determined that a material lot with material lot state information being “available” is presumed to be a cause of a defect of a shaped article after the material lot is input to the material dryer 120.

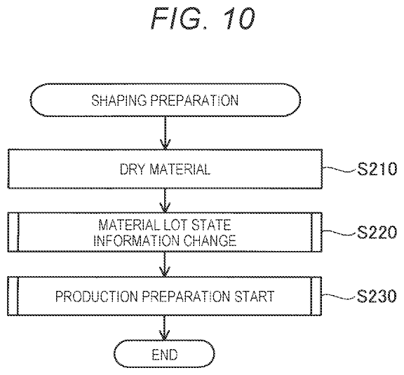

FIG. 10 is a diagram showing a process of shaping preparation executed in the second embodiment. The shaping preparation is processing executed before the injection molding machine 110 starts shaping a shaped article.

In step S210, the material lot used for shaping a shaped article is dried by the material dryer 120.

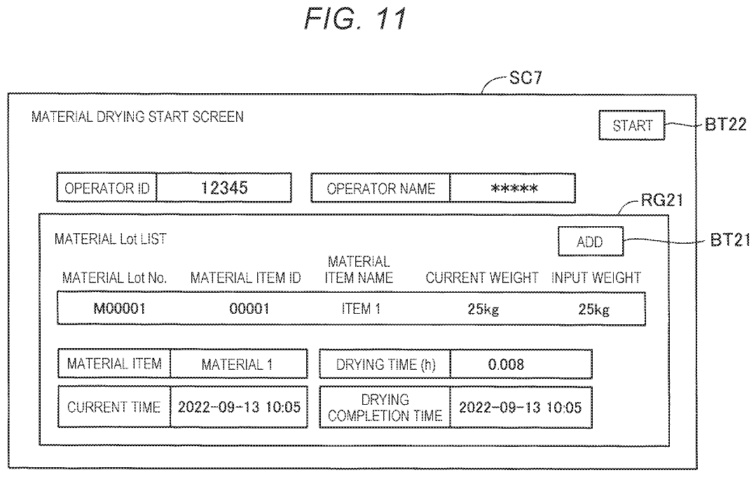

FIG. 11 is a diagram showing a material drying start screen SC7 generated by the screen generation unit 330 when the material is dried by the material dryer 120. The material drying start screen SC7 is provided with a material lot display region RG21, an add button BT21, and a start button BT22.

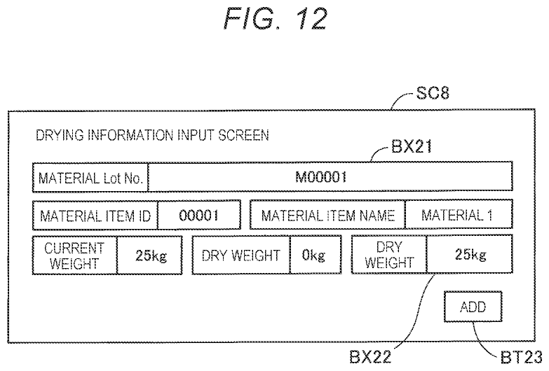

FIG. 12 is a diagram showing a drying information input screen SC8. The drying information input screen SC8 is generated by the screen generation unit 330 when the add button BT21 of the material drying start screen SC7 is clicked. The drying information input screen SC8 is provided with an input field BX21 for inputting material lot identification information, an input field BX22 for inputting a weight of a material to be dried, and an add button BT23. When drying the material with the material dryer 120, a user inputs a material lot number, which is the material lot identification information on the material lot to be dried, in the input field BX21, inputs the weight of the material lot to be dried in the input field BX22, and clicks the add button BT23.

When the add button BT23 is clicked in a state where information is input to the input field BX21 and the input field BX22, the screen generation unit 330 generates the material drying start screen SC7 on which material lot information input to the drying information input screen SC8 is displayed in the material lot display region RG21. The user inputs the material lot displayed in the material lot display region RG21 to the material dryer 120 and clicks the start button BT22. When the start button BT22 is clicked in a state where the material lot information is displayed in the material lot display region RG21, the management device 300 transmits a command to the material dryer 120 to start drying the material.

In step S220 in FIG. 10, the material lot state information change is executed. The material lot state information change executed in step S220 is the same as the material lot state information change in the first embodiment shown in FIG. 2. In step S220, the state information change unit 340 changes the material lot state information on the material lot input to the material dryer 120 in step S210 from “available” to “stopped”. For example, the state information change unit 340 changes the material lot state information on the material lot which is presumed to be the cause of the defect of the shaped article after being input to the material dryer 120 from “available” to “stopped”.

In step S230, production preparation start is executed. The production preparation start is processing executed by the management device 300 when the injection molding machine 110 starts shaping a shaped article.

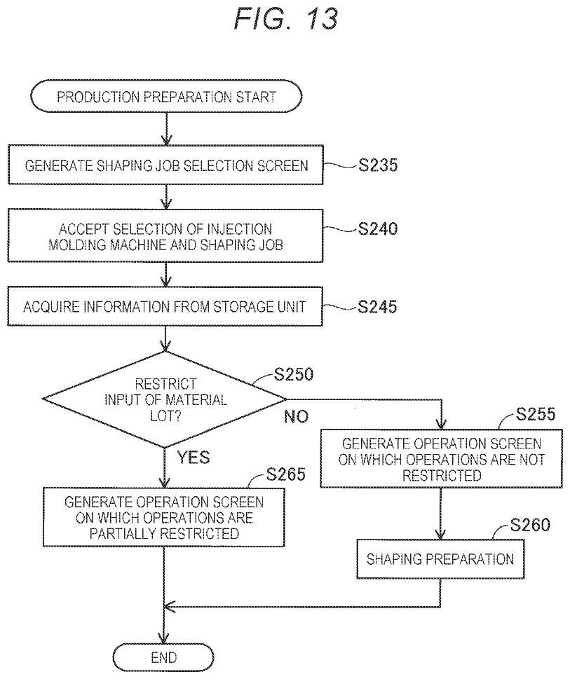

FIG. 13 is a diagram showing a process of the production preparation start.

In step S235, the screen generation unit 330 generates a shaping job selection screen SC9 on which the user selects the injection molding machine 110 used for shaping a shaped article and a shaping job for a shaped article to be executed by the injection molding machine 110.

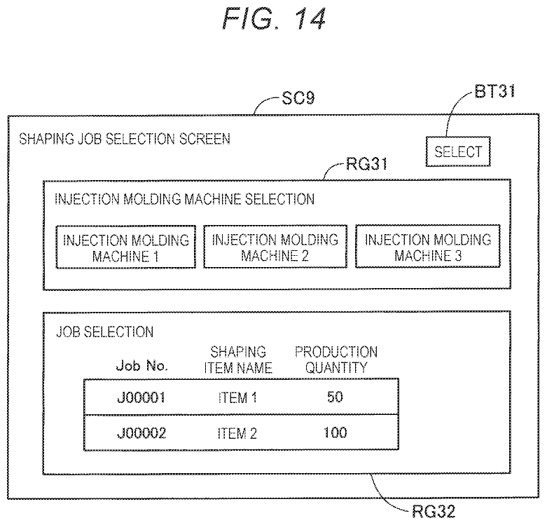

FIG. 14 is a diagram showing the shaping job selection screen SC9. The shaping job selection screen SC9 is provided with a shaping machine selection region RG31, a job selection region RG32, and a selection button BT31.

In step S240 in FIG. 13, the processing unit 301 accepts, from the user, selection of the injection molding machine 110 used for shaping a shaped article and the shaping job for a shaped article to be executed by the injection molding machine 110. In the shaping machine selection region RG31 of the shaping job selection screen SC9 shown in FIG. 14, a list of the injection molding machines 110 provided in the resin shaping system 100 is displayed. The user selects the injection molding machine 110 to be used for shaping a shaped article from the injection molding machines 110 displayed in the shaping machine selection region RG31. When the injection molding machine 110 is selected in the shaping machine selection region RG31, a list of shaping jobs for a shaped article executable by the injection molding machine 110 selected in the shaping machine selection region RG31 is displayed in the job selection region RG32. The user selects the shaping job to be executed from the shaping jobs displayed in the job selection region RG32, and clicks the selection button BT31. The shaping job is associated with the material lot identification information on the material lot to be used for shaping a shaped article.

In step S245 in FIG. 13, the acquisition unit 310 acquires, from the storage unit 302, the material lot identification information and the material lot state information on the material lot that is dried by the material dryer 120 and that is scheduled to be input to the injection molding machine 110 selected in step S240. Here, the material lot for which the material lot identification information and the material lot state information are acquired by the acquisition unit 310 is the material lot that is scheduled to be used in the shaping job selected in step S240.

In step S250, when the material lot state information on the material lot acquired in step S245 is “available”, the determination unit 320 determines not to restrict the input of the material lot to the injection molding machine 110. In this case, step S255 is executed after step S250. When the material lot state information on the material lot acquired in step S245 is “stopped”, the determination unit 320 determines to restrict the input of the material lot to the injection molding machine 110. In this case, step S265 is executed after step S250.

In step S255, the screen generation unit 330 generates a production preparation available screen SC10, which is an operation screen on which an operation by a user is not restricted.

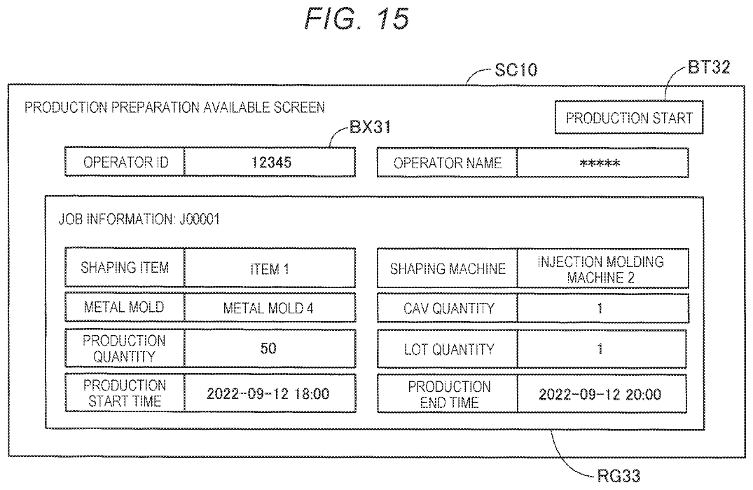

FIG. 15 is a diagram showing the production preparation available screen SC10. The production preparation available screen SC10 is provided with an input field BX31 for inputting user identification information, a production start button BT32, and a job information display region RG33. The user identification information is, for example, an ID number of the user. In the job information display region RG33, for example, information such as an item name of a shaped article, a metal mold used for shaping, a production quantity of a shaped article, a production start time, and a production end time is displayed.

In step S260 in FIG. 13, the user prepares for shaping a shaped article by the injection molding machine 110. The user inputs the user identification information in the input field BX31 of the production preparation available screen SC10, and performs a setup operation. Here, the setup operation is an operation of inputting a material to a hopper of the injection molding machine 110, attaching a metal to the injection molding machine 110, preheating an injection device or the metal mold of the injection molding machine 110, or the like. After the setup operation is completed, the user clicks the production start button BT32. When the production start button BT32 is clicked, the management device 300 transmits a command to the injection molding machine 110 to start shaping a shaped article.

In step S265, the screen generation unit 330 generates a production preparation stop screen SC11, which is an operation screen on which operations by a user are partially restricted.

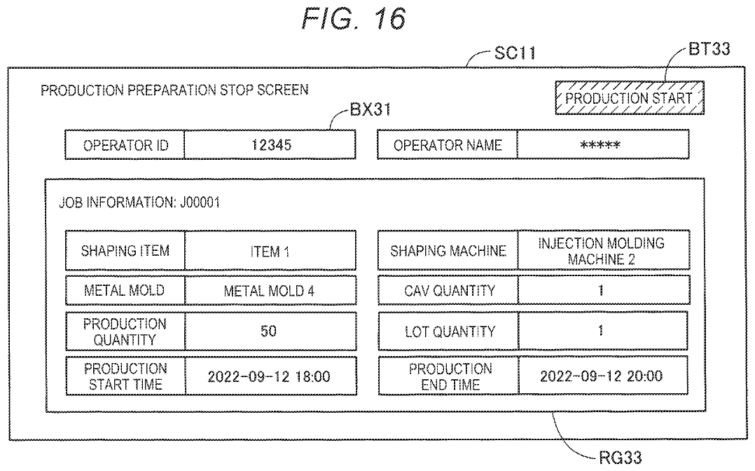

FIG. 16 is a diagram showing the production preparation stop screen SC11. The production preparation stop screen SC11 is provided with the input field BX31, a production start button BT33, and the job information display region RG33. The production start button BT33 is restricted in operation such that the user cannot click it. Therefore, in step S265, the management device 300 does not transmit a command to start shaping a shaped article to the injection molding machine 110. As described above, the production preparation start is executed.

According to the shaping material management system 10 in the second embodiment described above, in the shaping preparation, the material lot state information on the material lot that is dried by the material dryer 120 and that is not input to the injection molding machine 110 is changed from “available” to “stopped”. In the production preparation start, when the material lot state information on the material lot acquired by the acquisition unit 310 is “stopped”, the determination unit 320 determines to restrict the input of the material lot to the injection molding machine 110. When the determination unit 320 determines to restrict the input of the material lot to the resin shaping system 100, the screen generation unit 330 generates the production preparation stop screen SC11, which is an operation screen on which operations are partially restricted. The production preparation stop screen SC11 generated at this time is restricted in operation such that the user cannot click the production start button BT33. Therefore, even when it is determined that the material lot is the cause of the defect of the shaped article after the material lot is input to the material dryer 120, the material lot input to the material dryer 120 can be prevented from being input to the injection molding machine 110. Accordingly, shaping of a shaped article using a material lot presumed to be a cause of a defect of the shaped article can be prevented, and production of a defective article can be prevented.

### C. Third Embodiment

In the first embodiment, the material lot state information change is executed before the material lot is input to the resin shaping system 100, that is, before the material lot is input to the material dryer 120 or the injection molding machine 110. On the other hand, in the third embodiment, the material lot state information change is executed after the material lot is input to the injection molding machine 110 and before the injection molding machine 110 starts shaping a shaped d article. In the third embodiment, the material lot state information change is executed, for example, when it is determined that a material lot with the material lot state information being “available” is presumed to be a cause of a defect of a shaped article after the material lot is input to the injection molding machine 110. In the third embodiment, the material lot state information change is executed, for example, when it is determined that, in a case where after shaping of a shaped article is completed, a material lot that is used for shaping the shaped article and is already input to the injection molding machine 110 is used to shape a shaped article of another item, the material lot input to the injection molding machine 110 is presumed to be a cause of a defect of a shaped article.

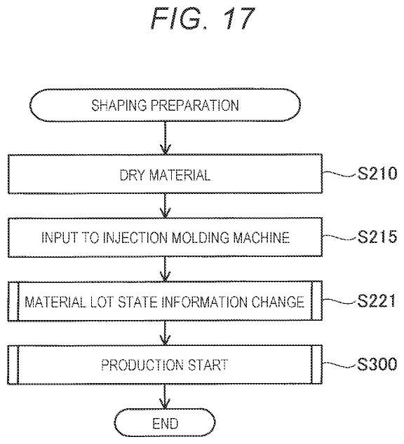

FIG. 17 is a diagram showing a process of shaping preparation in the third embodiment. A portion where processing same as the shaping preparation in the second embodiment shown in FIG. 10 is executed is denoted by the same reference numerals, and description thereof will be omitted.

In step S215, the material lot dried by the material dryer 120 is input to the injection molding machine 110.

In step S221, the material lot state information change is executed. The material lot state information change executed in step S221 is the same as the material lot state information change in the first embodiment shown in FIG. 2. In step S221, the state information change unit 340 changes the material lot state information on the material lot input to the injection molding machine 110 in step S215 from “available” to “stopped”. For example, the state information change unit 340 changes the material lot state information on the material lot that is determined to be presumed to be the cause of the defect of the shaped article after being input to the injection molding machine 110 from “available” to “stopped”.

In step S300, production start is executed. The production start is processing executed by the management device 300 when the injection molding machine 110 starts shaping a shaped article.

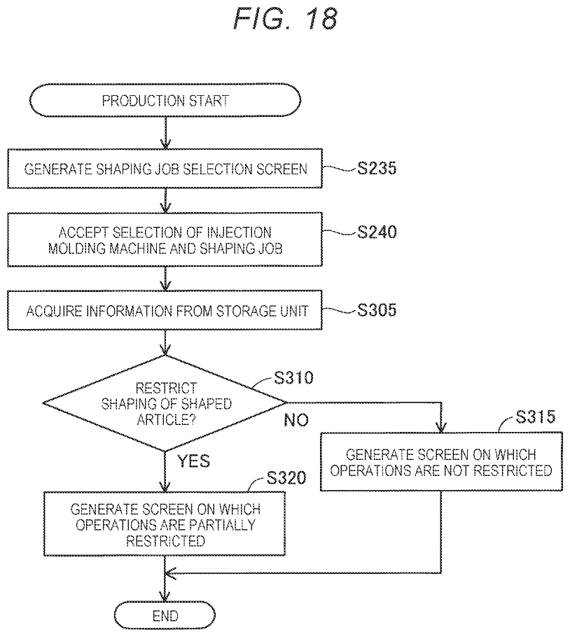

FIG. 18 is a diagram showing a process of the production start. A portion where processing same as the production preparation start in the second embodiment shown in FIG. 13 is executed is denoted by the same reference numerals, and description thereof will be omitted.

In step S305, the acquisition unit 310 acquires, from the storage unit 302, the material lot identification information and the material lot state information on the material lot input to the injection molding machine 110 selected in step S240.

In step S310, the determination unit 320 determines whether to restrict shaping of a shaped article using the material lot input to the injection molding machine 110. When the material lot state information on the material lot acquired in step S305 is “available”, the determination unit 320 determines not to restrict the shaping of the shaped article using the material lot. In this case, step S315 is executed after step S310. When the material lot state information on the material lot acquired in step S305 is “stopped”, the determination unit 320 determines to restrict the shaping of the shaped article using the material lot. In this case, step S320 is executed after step S310.

In step S315, the screen generation unit 330 generates a production available screen SC12, which is a screen on which an operation by the user is not restricted.

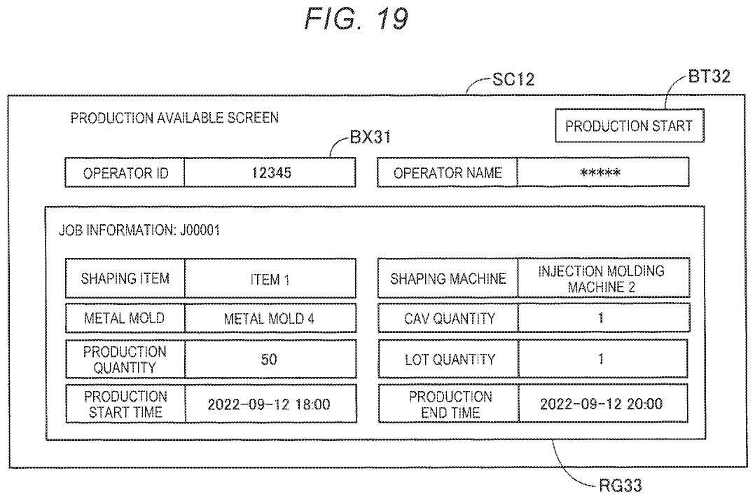

FIG. 19 is a diagram showing the production available screen SC12. The production available screen SC12 is provided with the input field BX31, the job information display region RG33, and the production start button BT32, similar to the production preparation available screen SC10 shown in FIG. 15. The user inputs user identification information in the input field BX31 and clicks the production start button BT32. When the production start button BT32 is clicked, the management device 300 transmits a command to the injection molding machine 110 to start shaping a shaped article.

In step S320, the screen generation unit 330 generates a production stop screen SC13, which is a screen on which operations by the user are partially restricted.

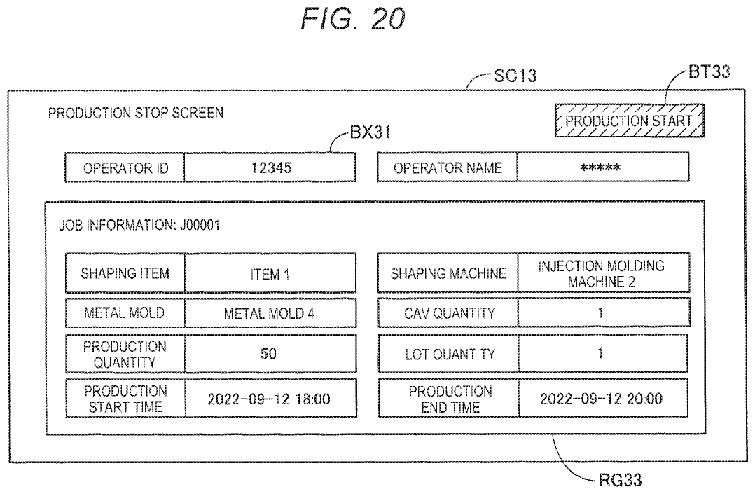

FIG. 20 is a diagram showing the production stop screen SC13. The production stop screen SC13 is provided with the input field BX31, the job information display region RG33, and the production start button BT33, similar to the production preparation stop screen SC11 shown in FIG. 16. The production start button BT33 is restricted in operation such that the user cannot click it. Therefore, in step S320, the management device 300 does not transmit a command to start shaping a shaped article to the injection molding machine 110. As described above, the production start is executed.

According to the shaping material management system 10 in the third embodiment described above, in the shaping preparation, the material lot state information on the material lot input to the injection molding machine 110 is changed from “available” to “stopped”. In the production preparation start, when the material lot state information on the material lot acquired by acquisition unit 310 is “stopped”, the determination unit 320 determines to restrict the shaping of the shaped article using the material lot. When the determination unit 320 determines to restrict the shaping of the shaped article using the material lot input to the injection molding machine 110, the screen generation unit 330 generates the production preparation stop screen SC11 on which a part of operations is restricted. The production preparation stop screen SC11 generated at this time is restricted in operation such that the user cannot click the production start button BT33. Therefore, even when it is determined that the material lot is presumed to be the cause of the defect of the shaped article after the material lot is input to the injection molding machine 110, the shaping of the shaped article using the material lot can be prevented. Accordingly, shaping of a shaped article using a material lot presumed to be a cause of a defect of the shaped article can be prevented, and production of a defective article can be prevented.

### D. Fourth Embodiment

In the material lot input in the first embodiment, when the material lot state information on the material lot selected on the material lot input preparation screen SC3 is “stopped”, the material lot input stop screen SC6, which is an operation screen on which operations are partially restricted, is generated. On the other hand, in material lot input in a fourth embodiment, when material lot state information on a material lot acquired by the acquisition unit 310 is “stopped”, an operation screen on which operations are partially restricted is generated.

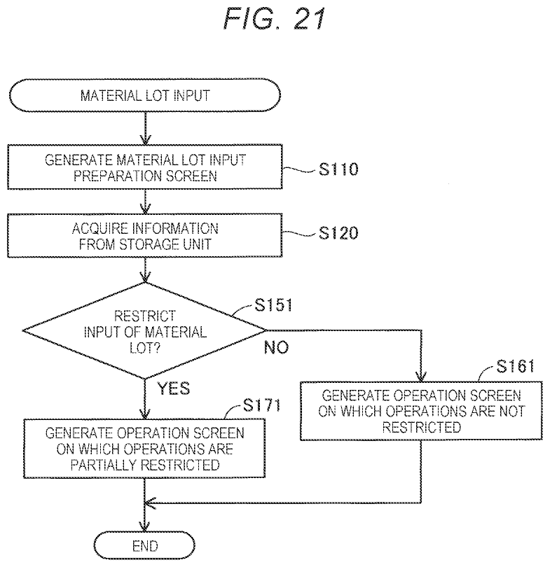

FIG. 21 is a diagram showing a process of the material lot input executed by the management device 300 in the fourth embodiment. A portion where processing same as the material lot input in the first embodiment shown in FIG. 5 is executed is denoted by the same reference numerals, and description thereof will be omitted.

In step S151, when the material lot state information on the material lot acquired by the acquisition unit 310 in step S120 is “available”, the determination unit 320 determines not to restrict the input of the material lot to the resin shaping system 100. In this case, step S161 is executed after step S151. When the material lot state information on the material lot acquired by the acquisition unit 310 in step S120 is “stopped”, the determination unit 320 determines to restrict the input of the material lot to the resin shaping system 100. In this case, step S171 is executed after step S151.

In step S161, the screen generation unit 330 generates an operation screen on which an operation by a user is not restricted. The operation screen generated in step S161 is a screen same as the material lot input screen SC4 shown in FIG. 7.

In Step S171, the screen generation unit 330 generates a second material lot input screen SC14, which is an operation screen on which operations by the user are partially restricted.

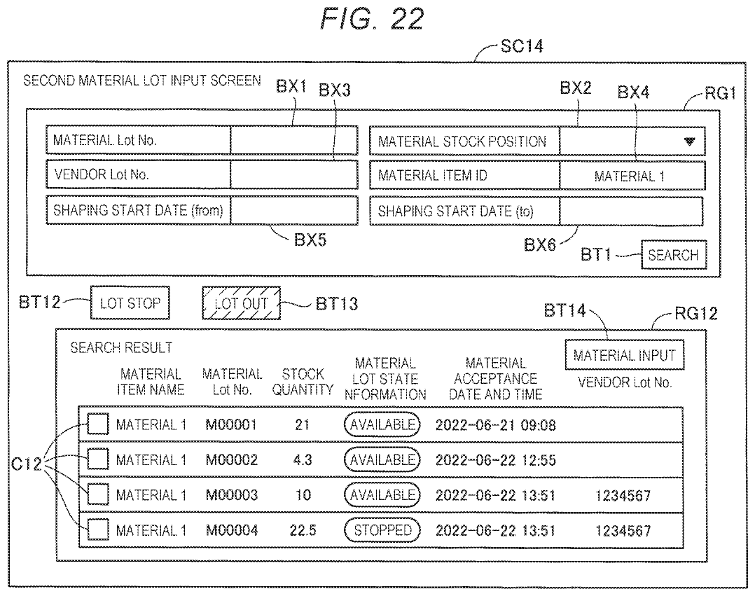

FIG. 22 is a diagram showing the second material lot input screen SC14. The second material lot input screen SC14 is a screen on which an operation of selecting the material lot determined to be restricted from being input to the resin shaping system 100 in step S151 is restricted. The second material lot screen SC14 has a input configuration same as that of the material lot input screen SC4 shown in FIG. 7 except for the checkbox C12. On the second material lot input screen SC14, the operation is restricted such that the user cannot select the checkbox C12 corresponding to the material lot determined to be restricted from being input to the resin shaping system 100 in step S151. In an example shown in FIG. 22, the operation is restricted such that the user cannot select the checkbox C12 of the material lot displayed in the lowermost portion of the search result display region RG12.

According to the shaping material management system 10 in the fourth embodiment described above, in the material lot input, the screen generation unit 330 generates the second material lot input screen SC14 on which the operation of selecting the material lot determined by the determination unit 320 to be restricted from being input to the resin shaping system 100 is restricted. Therefore, when inputting the material lot to the resin shaping system 100, the user can be prevented from selecting a material lot not to be input to the resin shaping system 100. Accordingly, erroneous input of the material to the resin shaping system 100 can be prevented.

### E. Fifth Embodiment

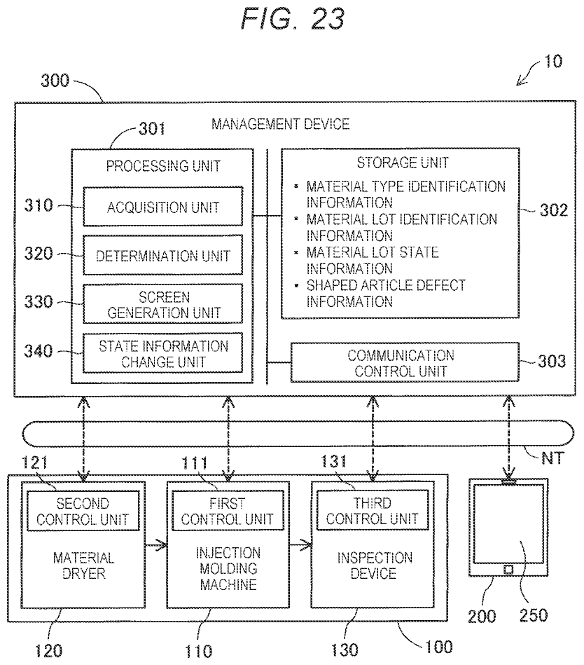

FIG. 23 is a diagram showing a schematic configuration of the shaping material management system 10 according to a fifth embodiment. In the embodiment, shaped article defect information is stored in the storage unit 302 in addition to material type identification information, material lot identification information, and material lot state information. The shaped article defect information is quantity information on a defect of a shaped article shaped by the resin shaping system 100. The shaped article defect information includes a defective rate, defective quantity, non-defective rate, and non-defective quantity of a shaped article, and the like.

The acquisition unit 310 acquires, from the storage unit 302, information including the material lot identification information, the material lot state information, and the shaped article defect information.

The determination unit 320 determines whether to restrict input of the material lot to the resin shaping system 100 based on the shaped article defect information acquired by the acquisition unit 310.

The state information change unit 340 changes the material lot state information acquired by the acquisition unit 310 based on the shaped article defect information acquired by the acquisition unit 310.

Hereinafter, material lot state information change executed by the management device 300 in the fifth embodiment will be described with reference to FIG. 2. A description of a portion where processing same as the material lot state information change in the first embodiment is executed will be omitted.

In step S20, the acquisition unit 310 acquires, from the storage unit 302, information including the material type identification information, the material lot identification information, the material lot state information, and the shaped article defect information on the material lot that matches information input to the input fields BX1 to BX6 of the material lot search screen SC1 in step S10.

In step S40, when the shaped article defect information acquired by the acquisition unit 310 deviates from a predetermined range, the state information change unit 340 changes the material lot state information on the material lot with the shaped article defect information deviating from the predetermined range from “available” to “stopped”. For example, the state information change unit 340 changes the material lot state information on the material lot used for shaping a shaped article for which a defective rate, defective quantity, non-defective rate, and non-defective quantity of the shaped article deviate from respective predetermined ranges from “available” to “stopped”.

Hereinafter, material lot input executed by the management device 300 in the fifth embodiment will be described with reference to FIG. 5. A description of a portion where processing same as the material lot input in the first embodiment is executed will be omitted.

In step S120, the acquisition unit 310 acquires, from the storage unit 302, information including the material lot identification information on the material lot composed of materials with the material type identification information input in the input field BX4 of the material lot input preparation screen SC3 and the material lot state information and the shaped article defect information associated with the material lot identification information.

In step S130, the screen generation unit 330 generates the material lot input screen SC4 on which the material lot state information changed by the state information change unit 340 in step S40 of the material lot state information change shown in FIG. 2 is displayed.

In step S150, the determination unit 320 determines whether to restrict input of the material lot to the resin shaping system 100 based on the shaped article defect information acquired by the acquisition unit 310 in step S120. When the material lot selected in step S140 is a material lot used for shaping a shaped article for which any of the defective rate, defective quantity, non-defective rate, and non-defective quantity of the shaped article does not deviate from the respective predetermined ranges, the determination unit 320 determines not to restrict the input of the material lot selected in step S140 to the resin shaping system 100. In this case, step S160 is executed after step S150. When the material lot selected in step S140 is a material lot used for shaping a shaped article for which any of the defective rate, defective quantity, non-defective rate, and non-defective quantity of the shaped article deviates from the respective predetermined ranges, the determination unit 320 determines to restrict the input of the material lot selected in step S140 to the resin shaping system 100. In this case, step S170 is executed after step S150.

According to the shaping material management system 10 in the fifth embodiment described above, the determination unit 320 determines to restrict the input of the material lot used for shaping the shaped article for which any of the defective rate, defective quantity, non-defective rate, and non-defective quantity of the shaped article deviates from the respective predetermined ranges to the resin shaping system 100. When the determination unit 320 determines to restrict the input of the material lot to the resin shaping system 100, the screen generation unit 330 generates the material lot input stop screen SC6, which is an operation screen on which operations are partially restricted. Therefore, the user can be prevented from inputting the material lot used for shaping the shaped article for which any of the defective rate, defective quantity, non-defective rate, and non-defective quantity of the shaped article deviates from the respective predetermined ranges to the resin shaping system 100. Accordingly, the user can be prevented from inputting, to the resin shaping system 100, a material lot not to be input to the resin shaping system 100, and production of defective products can be prevented.

In the embodiment, the screen generation unit 330 generates the material lot input screen SC4 on which the material lot state information changed by the state information change unit 340 is displayed. Therefore, the user can visually recognize whether the material lot can be input to the resin shaping system 100.

### F. Sixth Embodiment

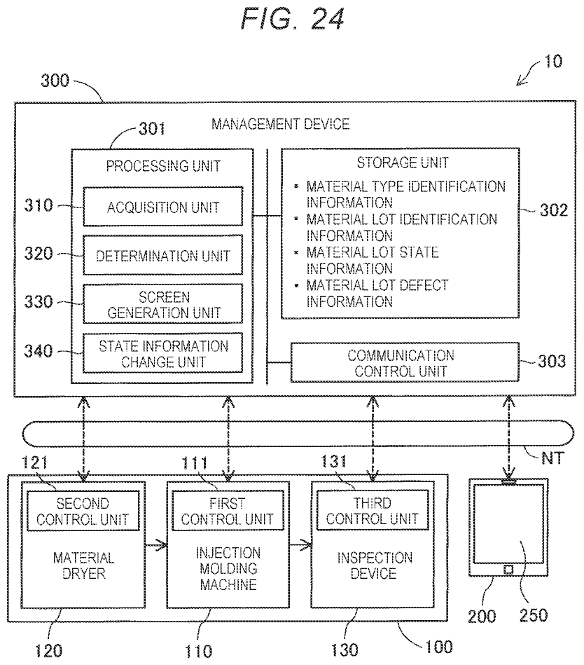

FIG. 24 is a diagram showing a schematic configuration of the shaping material management system 10 according to a sixth embodiment. In the embodiment, material lot defect information is stored in the storage unit 302 in addition to material type identification information, material lot identification information, and material lot state information. The material lot defect information is information on a defect of a material lot. The material lot defect information is “defective” when a material in the material lot is significantly deformed, discolored, or contaminated with impurities, for example, due to the material being dropped or stepped on when a user conveys the material.

The acquisition unit 310 acquires, from the storage unit 302, information including the material lot identification information, the material lot state information, and the material lot defect information.

The determination unit 320 determines whether to restrict input of the material lot to the resin shaping system 100 based on the material lot defect information acquired by the acquisition unit 310.

The state information change unit 340 changes the material lot state information acquired by the acquisition unit 310 based on the material lot defect information acquired by the acquisition unit 310.

Hereinafter, material lot state information change executed by the management device 300 in the sixth embodiment will be described with reference to FIG. 2. A description of a portion where processing same as the material lot state information change in the first embodiment is executed will be omitted.

In step S20, the acquisition unit 310 acquires, from the storage unit 3 information including the material type identification information, the material lot identification information, the material lot state information, and the material lot defect information on the material lot that matches the information input to the input fields BX1 to BX6 of the material lot search screen SC1 in step S10.

In step S40, the state information change unit 340 changes the material lot state information on the material lot supplied from a supply source of the material lot with the material lot defect information being defective from “available” to “stopped” during a predetermined period including a date and time when the material lot with the material lot defect information being defective is supplied. The predetermined period is, for example, a day on which the material lot with the material lot defect information being defective is supplied or a week including a day on which the material lot with the material lot defect information being defective is supplied. The supply source of the material lot is, for example, a wholesaler who delivers the material lot to a factory equipped with the shaping material management system 10, or a shaping material manufacturer.

Hereinafter, material lot input executed by the management device 300 in the sixth embodiment will be described with reference to FIG. 5. A description of a portion where processing same as the material lot input in the first embodiment is executed will be omitted.

In step S120, the acquisition unit 310 acquires, from the storage unit 302, information including the material lot identification information on the material lot composed of materials with the material type identification information input in the input field BX4 of the material lot input preparation screen SC3 and the material lot state information and the material lot defect information associated with the material lot identification information.

In step S130, the screen generation unit 330 generates the material lot input screen SC4 on which the material lot state information changed by the state information change unit 340 in step S40 of the material lot state information change shown in FIG. 2 is displayed.

In step S150, the determination unit 320 determines whether to restrict input of the material lot to the resin shaping system 100 based on the material lot defect information acquired by the acquisition unit 310 in step S120. When the material lot defect information on the material lot selected in step S140 is not defective, the determination unit 320 determines not to restrict the input of the material lot selected in step S140 to the resin shaping system 100. In this case, step S160 is executed after step S150. When the material lot defect information on the material lot selected in step S140 is defective, the determination unit 320 determines to restrict the input of the material lot selected in step S140 to the resin shaping system 100. In this case, step S170 is executed after step S150.

According to the shaping material management system 10 in the sixth embodiment described above, the determination unit 320 determines to restrict the input of the material lot with the material lot defect information being defective to the resin shaping system 100. When the determination unit 320 determines to restrict the input of the material lot to the resin shaping system 100, the screen generation unit 330 generates the material lot input stop screen SC6, which is an operation screen on which operations are partially restricted. Therefore, the user can be prevented from inputting the material lot with the material lot defect information being defective to the resin shaping system 100. Accordingly, the user can be prevented from inputting, to the resin shaping system 100, a material lot not to be input to the resin shaping system 100, and production of defective products can be prevented.

In the embodiment, the screen generation unit 330 generates the material lot input screen SC4 on which the material lot state information changed by the state information change unit 340 is displayed. Therefore, the user can visually recognize whether the material lot can be input to the resin shaping system 100.

### G. Seventh Embodiment

In the embodiment, after shaping of a shaped article is completed by the injection molding machine 110, inspection of the shaped article by the inspection device 130 and shipment on the system are executed. A configuration of the shaping material management system 10 in the embodiment is the same as that of any one of the first embodiment, the fifth embodiment, and the sixth embodiment.

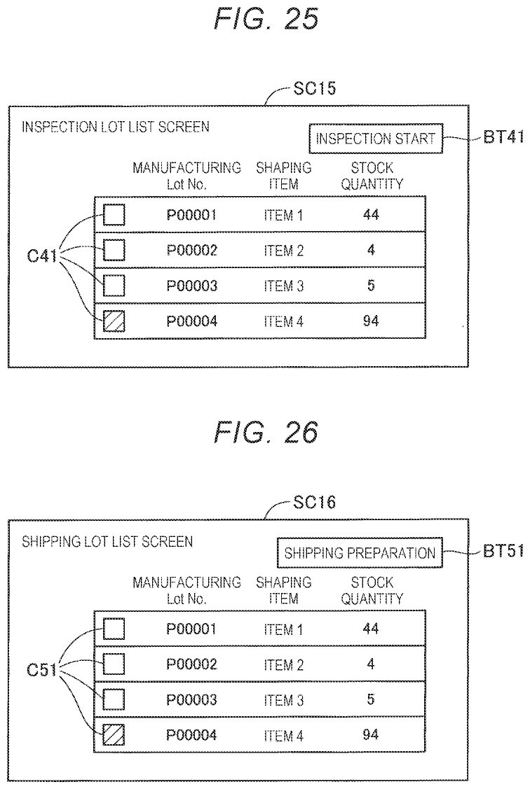

FIG. 25 is a diagram showing an inspection lot list screen SC15 generated by the screen generation unit 330 when a shaped article is inspected by the inspection device 130. A list of manufacturing lots, which are lots of shaped articles shaped by the injection molding machine 110, is displayed on the inspection lot list screen SC15. The inspection lot list screen SC15 is provided with an inspection start button BT41 and a checkbox C41 for selecting a manufacturing lot, which is associated with each manufacturing lot.

When generating the inspection lot list screen SC15, the screen generation unit 330 generates a screen on which an operation is restricted such that a user cannot select a manufacturing lot composed of shaped articles shaped using the material lot with the material lot state information change executed, that is, the material lot with material lot state information being “stopped”. Specifically, the screen generation unit 330 generates the inspection lot list screen SC15 on which an operation is restricted such that the user cannot check the checkbox C41 corresponding to the above-described manufacturing lot. In an example shown in FIG. 25, the operation is restricted such that the user cannot select the manufacturing lot displayed in the lowermost portion of the inspection lot list screen SC15. The screen generation unit 330 may generate the inspection lot list screen SC15 on which the above-described manufacturing lot is displayed in a color different from that of the manufacturing lot composed of the shaped articles shaped using the material lot with the material lot state information being “available”.

When the inspection start button BT41 is clicked in a state where the manufacturing lot is selected, the management device 300 transmits a command to the inspection device 130 to start inspecting the selected manufacturing lot.

FIG. 26 is a diagram showing a shipping lot list screen SC16 generated by the screen generation unit 330 when a shaped article is shipped. A list of manufacturing lots with shaping and inspection completed is displayed on the shipping lot list screen SC16. The shipping lot list screen SC16 is provided with a shipping preparation button BT51 and a checkbox C51 for selecting a manufacturing lot, which is associated with each manufacturing lot.

When generating the shipping lot list screen SC16, the screen generation unit 330 generates a screen on which an operation is restricted such that the user cannot select a manufacturing lot composed of shaped articles shaped using the material lot with the material lot state information change executed, that is, the material lot with material lot state information being “stopped”. Specifically, the screen generation unit 330 generates the shipping lot list screen SC16 on which an operation is restricted such that the user cannot check the checkbox C51 corresponding to the above-described manufacturing lot. In an example shown in FIG. 26, the operation is restricted such that the user cannot select the manufacturing lot displayed in the lowermost portion of the shipping lot list screen SC16. The screen generation unit 330 may generate the shipping lot list screen SC16 on which the above-described manufacturing lot is displayed in a color different from that of the manufacturing lot composed of the shaped articles shaped using the material lot with the material lot state information being “available”.

When the shipping preparation button BT51 is clicked in a state where the manufacturing lot is selected, the management device 300 causes the selected manufacturing lot to proceed to shipment on the system. Here, the shipment is, for example, processing in which a shipping destination of a manufacturing lot is determined.

According to the shaping material management system 10 in the seventh embodiment described above, when the inspection of the shaped article is performed by the inspection device 130, the screen generation unit 330 generates the inspection lot list screen SC15 on which the operation is restricted such that the user cannot select the manufacturing lot composed of the shaped articles shaped using the material lot with the material lot state information change executed, that is, the material lot with material lot state information being “stopped”. Therefore, the inspection device 130 can be prevented from inspecting a manufacturing lot that is likely to contain a defective product, and a time required for inspection can be shortened.

In the embodiment, when the shaped article is shipped, the screen generation unit 330 generates the shipping lot list screen SC16 on which the operation is restricted such that the user cannot select the manufacturing lot composed of the shaped articles shaped using the material lot with the material lot state information change executed, that is, the material lot with material lot state information being “stopped”. Therefore, the shipment of the manufacturing lot that is likely to contain a defective product can be prevented.

### H. Other Embodiments

(H-1) In the above embodiment, the screen generation unit 330 generates an operation screen on which a plurality of pieces of material lot identification information are displayed. The operation screen on which a plurality of pieces of material lot identification information are displayed is, for example, the material lot input screen SC4 shown in FIG. 7 or the second material lot input screen SC14 shown in FIG. 22. On the other hand, the screen generation unit 330 may generate an operation screen for each material lot. That is, the screen generation unit 330 may generate the material lot input screen SC4 or the second material lot input screen SC14 for each material lot.

(H-2) In the above embodiment, the screen generation unit 330 generates an operation screen on which an operation of discarding a material lot is not enabled. The operation screen on which an operation of discarding a material lot is not enabled is, for example, the material lot input screen SC4 or the second material lot input screen SC14. The material lot input screen SC4 and the second material lot input screen SC14 are provided with the lot discard button BT13 that cannot be clicked by the user.

On the other hand, the screen generation unit 330 may generate an operation screen on which an operation of discarding a material lot determined by the determination unit 320 to be restricted from being input to the resin shaping system 100 is enabled. Specifically, when the material lot determined by the determination unit 320 to be restricted from being input to the resin shaping system 100 is selected, the screen generation unit 330 may generate the material lot input screen SC4 or the second material lot input screen SC14 on which the user can click the lot discard button BT13. In this case, when the lot discard button BT13 is clicked in a state where the material lot determined by the determination unit 320 to be restricted from being input to the resin shaping system 100 is selected in the material lot input screen SC4 or the second material lot input screen SC14, the management device 300 executes disposal of the selected material lot on the system. The management device 300 displays, for example, a notification indicating that the selected material lot is discarded on the display unit 250.

In this case, since it is not possible for the user to execute the operation of discarding the material lot determined by the determination unit 320 not to be restricted from being input to the resin shaping system 100 in the material lot input screen SC4 or the second material lot input screen SC14, a material lot other than the material lot not to be input to the resin shaping system 100 can be prevented from being erroneously discarded.

(H-3) In the fourth embodiment, the screen generation unit 330 generates the second material lot input screen SC14, which is an operation screen on which an operation of selecting a material lot determined to be restricted from being input to the resin shaping system 100 is restricted. On the other hand, the screen generation unit 330 may generate an operation screen on which an operation of inputting, to the resin shaping system 100, the material lot determined to be restricted from being input to the resin shaping system 100 is restricted. Specifically, in step S171 in FIG. 21, when the material lot determined to be restricted from being input to the resin shaping system 100 in step S151 is selected, the screen generation unit 330 may generate the second material lot input screen SC14 which is restricted in operation such that the material input button BT14 cannot be clicked.

(H-4) In the fifth embodiment, in step S40 of the material lot state information change shown in FIG. 2, when shaped article defect information acquired by the acquisition unit 310 deviates from a predetermined range, the state information change unit 340 changes material lot state information on a material lot with the shaped article defect information deviating from the predetermined range from “available” to “stopped”. On the other hand, as in the first embodiment, when the user selects the material lot with the shaped article defect information deviating from the predetermined range on the material lot list screen SC2, the state information change unit 340 may change the material lot state information on the selected material lot from “available” to “stopped”.

(H-5) In the fifth embodiment, the processing unit 301 includes the state information change unit 340. On the other hand, the processing unit 301 may not include the state information change unit 340. In this case, the material lot state information change may not be executed.

(H-6) In the sixth embodiment, in step S40 of the material lot state information change shown in FIG. 2, the state information change unit 340 changes material lot state information on a material lot supplied from a supply source of a material lot with material lot defect information acquired by the acquisition unit 310 being defective from “available” a to “stopped” during predetermined period including a date and time when the material lot with the material lot defect information being defective is supplied. On the other hand, as in the first embodiment, when the user selects the material lot supplied from the supply source of the material lot with the material lot defect information being defective on the material lot list screen SC2 during the predetermined period including the date and time when the material lot with the material lot defect information being defective is supplied, the state information change unit 340 may change the material lot state information on the selected material lot from “available” to “stopped”.

(H-7) In the sixth embodiment, the processing unit 301 includes the state information change unit 340. On the other hand, the processing unit 301 may not include the state information change unit 340. In this case, the material lot state information change may not be executed.

(H-8) In the above embodiment, the resin shaping system 100 includes the injection molding machine 110, the material dryer 120, and the inspection device 130. On the other hand, the resin shaping system 100 may include, for example, an extrusion molding machine or a blow molding machine instead of the injection molding machine 110. When the resin shaping system 100 includes an extrusion molding machine, inputting the material lot to the resin shaping system 100 means inputting the material lot to the extrusion molding machine or the material dryer 120. When the resin shaping system 100 includes a blow molding machine, inputting the material lot to the resin shaping system 100 means inputting the material lot to the blow molding machine or the material dryer 120. The resin shaping system 100 may include the injection molding machine 110 and an extrusion molding machine, may include the injection molding machine 110 and a blow molding machine, or may include the injection molding machine 110, an extrusion molding machine, and a blow molding machine.

### I. Other Aspects:

The present disclosure is not limited to the embodiments described above, and can be implemented in various forms without departing from the scope of the present disclosure. For example, the present disclosure can be implemented in the following aspects. In order to solve a part of or all of problems of the present disclosure, or to achieve a part of or all of effects of the present disclosure, technical features of the above-described embodiments corresponding to technical features in each of the following aspects can be replaced or combined as appropriate. Technical characteristics can be deleted as appropriate unless described as essential in the present specification.

(1) According to an aspect of the present disclosure, a shaping material management system is provided. The shaping material management system is a shaping material management system for managing a material used in a resin shaping system. The shaping material management system includes: a storage unit configured to store material lot identification information, which is information on a lot of the material, and material lot state information including information as to whether a material lot, which is the lot of the material, is able to be input to the resin shaping system; an acquisition unit configured to acquire the material lot identification information and the material lot state information from the storage unit; a determination unit configured to determine whether to restrict input of the material lot to the resin shaping system based on the material lot state information acquired by the acquisition unit; and a screen generation unit configured to generate an operation screen, which is a screen to be operated when the material lot is input to the resin shaping system. When the determination unit determines to restrict the input of the material lot to the resin shaping system, operations are partially restricted on the operation screen generated by the screen generation unit.

According to this aspect, the user can be prevented from erroneously inputting a material lot not to be input to the resin shaping system. Accordingly, erroneous input of the material to the resin shaping system can be prevented.

(2) In the above aspect, a plurality of pieces of the material lot identification information may be displayed on the operation screen generated by the screen generation unit.

According to this aspect, unlike the case where the material lot input screen is generated for each material lot, it is not necessary to check the material lot input screen one by one, and thus the work efficiency of the user can be improved.

(3) In the above aspect, when the determination unit determines to restrict the input of the material lot to the resin shaping system, an operation of selecting the material lot determined to be restricted from being input to the resin shaping system may be restricted on the operation screen generated by the screen generation unit.

According to this aspect, when the user inputs the material lot to the resin shaping system, selection of the material lot not to be input to the resin shaping system can be prevented.

(4) In the above aspect, when the determination unit determines to restrict the input of the material lot to the resin shaping system, an operation of inputting, to the resin shaping system, the material lot determined to be restricted from being input to the resin shaping system may be restricted on the operation screen generated by the screen generation unit.

According to this aspect, when the user inputs the material lot to the resin shaping system, even when the user selects the material lot not to be input to the resin shaping system, the selected material lot can be prevented from being input to the resin shaping system.

(5) In the above aspect, when the determination unit determines to restrict the input of the material lot to the resin shaping system, an operation of discarding the material lot determined to be restricted from being input to the resin shaping system may be enabled on the operation screen generated by the screen generation unit.

According to this aspect, the material lot not to be input to the resin shaping system can be discarded at a stage of inputting the material lot to the resin shaping system.

(6) According to an aspect of the present disclosure, a shaping material management system is provided. The shaping material management system is a shaping material management system for managing a material used in a resin shaping system. The shaping material management system includes: a storage unit configured to store material lot identification information, which is information on a lot of the material, material lot state information including information as to whether a material lot, which is the lot of the material, is able to be input to the resin shaping system, and shaped article defect information, which is quantity information on a defect of a shaped article shaped by the resin shaping system; an acquisition unit configured to acquire the material lot identification information and the shaped article defect information from the storage unit; a determination unit configured to determine whether to restrict input of the material lot to the resin shaping system based on the shaped article defect information acquired by the acquisition unit; and a screen generation unit configured to generate an operation screen, which is a screen to be operated when the material lot is input to the resin shaping system. When the determination unit determines to restrict the input of the material lot to the resin shaping system, operations are partially restricted on the operation screen generated by the screen generation unit.

According to this aspect, the user can be prevented from erroneously inputting a material lot not to be input to the resin shaping system. Accordingly, erroneous input of the material to the resin shaping system can be prevented.

(7) In the above aspect, the acquisition unit may acquire the material lot state information from the storage unit. The shaping material management system may include a state information change unit configured to change the material lot state information acquired by the acquisition unit based on the shaped article defect information acquired by the acquisition unit. When the shaped article defect information deviates from a predetermined range, the shaped article defect information may deviate from the predetermined range in the material lot state information of the material lot changed by the state information change unit. The material lot state information changed by the state information change unit may be displayed on the operation screen generated by the screen generation unit.

According to this aspect, the user can visually recognize whether the material lot can be input to the resin shaping system.

(8) According to an aspect of the present disclosure, a shaping material management system is provided. The shaping material management system is a shaping material management system for managing a material used in a resin shaping system. The shaping material management system includes: a storage unit configured to store material lot identification information, which is information on a lot of the material, material lot state information including information as to whether a material lot, which is the lot of the material, is able to be input to the resin shaping system, and material lot defect information, which is information on a defect of the material lot; an acquisition unit configured to acquire the material lot identification information and the material lot defect information from the storage unit; a determination unit configured to determine whether to restrict input of the material lot to the resin shaping system based on the material lot defect information acquired by the acquisition unit; and a screen generation unit configured to generate an operation screen, which is a screen to be operated when the material lot is input to the resin shaping system. When the determination unit determines to restrict the input of the material lot to the resin shaping system, operations are partially restricted on the operation screen generated by the screen generation unit.

According to this aspect, the user can be prevented from erroneously inputting a material lot not to be input to the resin shaping system. Accordingly, erroneous input of the material to the resin shaping system can be prevented.

(9) In the above aspect, the acquisition unit may acquire the material lot state information from the storage unit. The shaping material management system may include a state information change unit configured to change the material lot state information acquired by the acquisition unit based on the material lot defect information acquired by the acquisition unit. The state information change unit may change the material lot state information of the material lot supplied from a supply source of the material lot with the material lot defect information being defective during a predetermined period including a date and time when the material lot with the material lot defect information being defective is supplied. The material lot state information changed by the state information change unit may be displayed on the operation screen generated by the screen generation unit.

According to this aspect, the user can visually recognize whether the material lot can be input to the resin shaping system.

What is claimed is:

1. A shaping material management system for managing a material used in a resin shaping system, the shaping material management system comprising:
a storage unit configured to store material lot identification information, which is information on a lot of the material, and material lot state information including information as to whether a material lot, which is the lot of the material, is able to be input to the resin shaping system;
an acquisition unit configured to acquire the material lot identification information and the material lot state information from the storage unit;
a determination unit configured to determine whether to restrict input of the material lot to the resin shaping system based on the material lot state information acquired by the acquisition unit; and
a screen generation unit configured to generate an operation screen, which is a screen to be operated when the material lot is input to the resin shaping system, wherein
when the determination unit determines to restrict the input of the material lot to the resin shaping system, operations are partially restricted on the operation screen generated by the screen generation unit.

2. The shaping material management system according to claim 1, wherein
a plurality of pieces of the material lot identification information are displayed on the operation screen generated by the screen generation unit.

3. The shaping material management system according to claim 2, wherein
when the determination unit determines to restrict the input of the material lot to the resin shaping system, an operation of selecting the material lot determined to be restricted from being input to the resin shaping system is restricted on the operation screen generated by the screen generation unit.

4. The shaping material management system according to claim 1, wherein
when the determination unit determines to restrict the input of the material lot to the resin shaping system, an operation of inputting, to the resin shaping system, the material lot determined to be restricted from being input to the resin shaping system is restricted on the operation screen generated by the screen generation unit.

5. The shaping material management system according to claim 1, wherein
when the determination unit determines to restrict the input of the material lot to the resin shaping system, an operation of discarding the material lot determined to be restricted from being input to the resin shaping system is enabled on the operation screen generated by the screen generation unit.

6. A shaping material management system for managing a material used in a resin shaping system, the shaping material management system comprising:
a storage unit configured to store material lot identification information, which is information on a lot of the material, material lot state information including information as to whether a material lot, which is the lot of the material, is able to be input to the resin shaping system, and shaped article defect information, which is quantity information on a defect of a shaped article shaped by the resin shaping system;
an acquisition unit configured to acquire the material lot identification information and the shaped article defect information from the storage unit;
a determination unit configured to determine whether to restrict input of the material lot to the resin shaping system based on the shaped article defect information acquired by the acquisition unit; and
a screen generation unit configured to generate an operation screen, which is a screen to be operated when the material lot is input to the resin shaping system, wherein
when the determination unit determines to restrict the input of the material lot to the resin shaping system, operations are partially restricted on the operation screen generated by the screen generation unit.

7. The shaping material management system according to claim 6, wherein
the acquisition unit acquires the material lot state information from the storage unit,
the shaping material management system comprises a state information change unit configured to change the material lot state information acquired by the acquisition unit based on the shaped article defect information acquired by the acquisition unit,
when the shaped article defect information deviates from a predetermined range, the shaped article defect information deviates from the predetermined range in the material lot state information on the material lot changed by the state information change unit, and
the material lot state information changed by the state information change unit is displayed on the operation screen generated by the screen generation unit.

8. A shaping material management system for managing a material used in a resin shaping system, the shaping material management system comprising:
a storage unit configured to store material lot identification information, which is information on a lot of the material, material lot state information including information as to whether a material lot, which is the lot of the material, is able to be input to the resin shaping system, and material lot defect information, which is information on a defect of the material lot;
an acquisition unit configured to acquire the material lot identification information and the material lot defect information from the storage unit;
a determination unit configured to determine whether to restrict input of the material lot to the resin shaping system based on the material lot defect information acquired by the acquisition unit; and
a screen generation unit configured to generate an operation screen, which is a screen to be operated when the material lot is input to the resin shaping system, wherein
when the determination unit determines to restrict the input of the material lot to the resin shaping system, operations are partially restricted on the operation screen generated by the screen generation unit.

9. The shaping material management system according to claim 8, wherein
the acquisition unit acquires the material lot state information from the storage unit,
the shaping material management system comprises a state information change unit configured to change the material lot state information acquired by the acquisition unit based on the material lot defect information acquired by the acquisition unit,
the state information change unit changes the material lot state information on the material lot supplied from a supply source of the material lot with the material lot defect information being defective during a predetermined period including a date and time when the material lot with the material lot defect information being defective is supplied, and
the material lot state information changed by the state information change unit is displayed on the operation screen generated by the screen generation unit.
